(19) United States
(12) Patent Application Publication
(10) Pub. No.: US 2007/0173971 A1
(43) Pub. Date: Jul. 26, 2007

(54) SYSTEM AND METHOD OF PROVIDING MEDICATION COMPLIANCE PACKAGING

(75) Inventors: Marvin R. Richardson, Wayzata, MN (US); John J. Brady, Prior Lake, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: PrairieStone Pharmacy, LLC, Plymouth, MN (US)

(21) Appl. No.: 11/627,619

(22) Filed: Jan. 26, 2007

Related U.S. Application Data
(60) Provisional application No. 60/762,970, filed on Jan. 26, 2006.

(51) Int. Cl. G06F 17/00

(52) U.S. Cl. 700/231

(57) ABSTRACT

An interface between a compliance packaging device and a pharmacy transaction system includes accepting a pharmaceutical order from a user of a pharmacy transaction system, entering the order into a database, reading the order from the database, and communicating the order to the compliance packaging device. The pharmaceutical order may be entered into a database at a site remote from the site housing the compliance packaging device. The compliance packaging device may further produce a medication pouch tape, which can optionally be stored in a dispenser box and provided to a consumer.

### RELATED APPLICATION

This application claims priority to U.S. Provisional Application No. 60/762,970, filed Jan. 26, 2006, titled SYSTEM AND METHOD OF PROVIDING MEDICATION COMPLIANCE PACKAGING, now pending and incorporated by reference in its entirety.

### TECHNICAL FIELD

This document relates to medication administration for patients in independent living situations.

### BACKGROUND

For people who are living independently, and have been prescribed or are otherwise taking multiple medications, the administration of those medications can be inconvenient, and dangerous situations can arise if errors are made. Typically, the consumer of the medication involved in a multi-medication regimen for a chronic condition takes the medications according to multiple label instructions at the direction of a prescribing professional (e.g. a physician, physician assistant, or nurse). Often, because of limited technology and limited involvement by retail pharmacies, the consumer is left to dispense the medications in a plastic matrix container divided by day and/or time, in which medications (usually pills, capsules, or other solid or semisolid media) are arranged in cells corresponding to a particular day or time when the medication is to be administered. Consumers living independently manage this cumbersome process themselves or they may receive help from family members in arranging medications in such matrix boxes or otherwise administering the medication. In either case, this often leads to a situation in which personnel without medical or pharmaceutical training are responsible for adherence to or compliance with a prescribed medication regimen. This is inconvenient to the patient and amateur caregivers, and can result in errors in administration and dangerous drug interactions, which have been well documented. Both administration errors and dangerous interactions can lead to adverse medical effects that reduce or defeat the benefit that otherwise could be derived from the treatment regimen. Often this medication mismanagement and its adverse effects can cause greater problems than those the patient originally presented, and in some extreme situations may even result in more serious or deadly consequences for the patient. In the aggregate, these dangers cause an adverse impact on the medical care capacity of the health care system as a whole and increase health care expenses, not to mention the considerable stress that such events place on patients and their family or other caregivers.

Devices that provide pre-packaged medication doses for patients are used by in-patient caregivers, especially in-patient caregivers such as nursing homes, hospices, and other long-term care facilities. These devices generally produce a string or roll of connected small pouches (“pouch tape”) in which the individual pouches are removably connected together (e.g., by perforations between the pouches). A length of pouches (e.g., on a roll), filled with medication as prescribed to patients at the facility, may be stored or mounted on a “med cart” that is wheeled around to patients' bedside, stations, or other locations where the drugs are to be administered. A particular patient's pouches can be left at his/her designated station. The pouches can be marked with (a) instructions concerning how to administer the drug, (b) which drug should be in the pouch, (c) instructions concerning when to administer the drug, and (d) other relevant instructions warnings, and/or information. The contents of the pouch may be placed in a paper pill cup for the patient. The pouch tape will typically dispense medications for a number of patients in a single tape according to ward, floor, or other route of the med cart so that the pouch tape may be divided or allocated conveniently by the med cart operator. In such “institutional” environments, paid caregivers are often held accountable for the oversight and management of the prescription drug(s). Moreover, such facilities often contract with a specialized pharmacy or “long term care” pharmacy to provide and dispense such value added packaging services.

### SUMMARY

A computer-readable medium in embodiments of the present invention can include instructions for interfacing a compliance packaging device and a pharmacy transaction system where the instructions can cause a programmable processor to accept a pharmaceutical order from a pharmacy transaction system user, enter the order into a database, read the order from the database, and communicate the pharmaceutical order to the compliance packaging device. The instructions can cause a programmable processor to display and/or update a patient's pharmacological profile. Further, the pharmaceutical order can be stored in the database as a batch file for a specific pharmacy site, including a pharmacy site comprising a retail pharmacy or a mail order pharmacy, and in some embodiments, the pharmaceutical order can be entered at a pharmacy site remote from a site housing the compliance packaging device. The user can further be allowed to select the compliance packaging device.

A computer-readable medium in embodiments of the present invention can include instructions for interfacing a compliance packaging device and a pharmacy transaction system where the instructions can cause a programmable processor to accept a pharmaceutical order entered by a pharmacy transaction system user at a first site, enter the order into a database at the first site, read the order from the database at the first site from a second site, and communicate the pharmaceutical order to the compliance packaging device at the second site. The transaction system user can be allowed to set scheduled times to transfer a pharmaceutical order to the second site, and/or select the compliance packing device. The compliance packaging device can produce a medication pouch tape, and the instructions can cause a programmable processor to review and update a patient's pharmacological profile.

A method for providing medication compliance packaging can include entering a pharmaceutical order into a database at a local pharmacy, reading the pharmaceutical order from the database, and communicating the pharmaceutical order to a compliance packaging device at a compliance packaging hub. The method can further include receiving the pharmaceutical order from a patient at a first site, reviewing and updating the patient's pharmacological profile stored on the database, verifying the patient's order on the database against a hard copy of the patient's order, pulling the patient's orders from the local pharmacy to the compliance packaging hub, and scheduling times for the patient's orders to be pulled from the local pharmacy. The method can further include the steps of selecting a compliance packaging device and storing a medication pouch tape created by the compliance packaging device in a pill dispenser box.

A method for providing medication compliance packaging can include receiving a first pharmaceutical order from a first pharmacy transaction system, where the first pharmaceutical order corresponds to a prescription of a first consumer, generating a first medication pouch tape with a compliance packaging device in response to the first pharmaceutical order, and providing the first medication pouch tape to the first consumer. The first pharmacy transaction system can be located at a first remote location. The method can further include receiving a second pharmaceutical order from a second pharmacy transaction system located at a second remote location, where the second pharmaceutical order corresponds to a prescription of a second consumer, generating a second medication pouch tape with the compliance packaging device in response to the second pharmaceutical order, and providing the second medication pouch tape to the second consumer. In addition, the method can include packaging the first medication pouch tape in a box, and providing the first medication pouch tape to the first consumer by providing the box to the first consumer. The box can be synchronized to a timer. Providing the medication pouch tape to the first consumer can include providing the medication pouch tape directly to the first consumer or to a pharmacy located a remote location. The method can include receiving instructions for assigning a medication product to the compliance packaging device, informing the compliance packaging device how to retrieve the first pharmaceutical order, and/or printing a label to be affixed to the first medication pouch tape. Further, the first pharmaceutical order can be included in a plurality of pharmaceutical orders in a batch file

A method for providing medication compliance packaging can include generating a first pharmaceutical order that corresponds to a prescription of a consumer, providing the first pharmaceutical order to a compliance packaging hub that is configured to generate a medication pouch tape with a first compliance packaging device in response to the first pharmaceutical order, and receiving the medication pouch tape from the compliance packaging hub. In addition, the first compliance packaging hub can optionally be located at a remote location. The method can also include the step of selecting the first compliance packaging device from a plurality of compliance packaging devices accessible to the compliance packaging hub. The method can further include collecting a plurality of pharmaceutical orders in a first batch file, where the first batch file includes the first pharmaceutical order, and providing the first pharmaceutical order to the compliance packaging hub involves providing the first batch file to the compliance packaging hub. The method can further include the step of scheduling a series of times for providing batch files to the compliance packaging hub, wherein providing the first batch file to the compliance packaging hub involves providing the first batch file at one of the scheduled times. The method can further include the steps of generating a second pharmaceutical order that corresponds to the prescription of the consumer and dispensing medication in response to the second pharmaceutical order via a vial-dispensed system. Generating the first pharmaceutical order can also involve using a SIG code that refers to a frequency with which a medication is to be administered but does not specify a pass time. Further, the method can involve establishing a default pass time for the SIG code or modifying the default pass time for the consumer. The method can also include the steps of generating instructions concerning printing a label to be affixed to the medication pouch tape and providing the instructions to the compliance packaging hub, in addition to providing a hard copy of the prescription to the compliance packaging hub.

Some embodiments may have one or more of the following advantages. Some embodiments can increase the safety of patients. For example, having medication in labeled, single-dose pouches can increase the likelihood that a patient will remember to take his or her medication, and maintaining a regular regimen is often critical in deriving the full benefit of prescribed medication. Moreover, single-dose pouches increase the likelihood that the patient will take the right amount of medication. Some embodiments of the present invention can improve safety by creating one or more extra precautions against dangerous medication combinations, and may therefore lessen the risk of potential life-threatening adverse drug reactions. Some embodiments increase the convenience of patients (or caregivers) by eliminating the need to transfer medication from vials into matrix boxes. Such embodiments can also increase patient safety in that they can eliminate errors made during this transfer process. Some embodiments can make use of existing technology, thereby allowing users to gain maximum benefits for minimal costs. For example, some embodiments can make use of generic drugs, over-the-counter drugs or “formulary preferred” medications. Some embodiments can provide benefits typically enjoyed only by patients in in-patient settings to patients who are living independently. Some embodiments can inherently provide medication oversight, such as through the set-up of medication pouches by a pharmacist. Some embodiments can allow a pharmacist to recommend modifications or additions to a medication regimen when appropriate. For example, in some embodiments a pharmacist can recommend to a patient or physician additional over-the-counter dosing such as a once-a-day vitamin or calcium supplement. Some embodiments can facilitate the dispensing of medications eat the proper therapeutic dosing time of day in order to enhance product effectiveness. For example, some embodiments can facilitate taking a cholesterol lowering agent in the evening versus the morning. In some embodiments, a monthly cycle fill of medication pouches can increase the likelihood that all medications are filled and taken as prescribed, thus, for example, eliminating missed trips to the pharmacy to get one or more prescriptions filled during a given month.

### DRAWINGS

FIG. 1 shows a medication pouch tape creating device for use in some embodiments of the present invention.

FIG. 2 shows a representation of an interface display for initial setup of a compliance packaging device in some embodiments of the present invention.

FIG. 3 shows a representation of an interface display for setting up a general scheduler in some embodiments of the present invention.

FIG. 4 shows a representation of an interface display for setting up a recurring scheduler in some embodiments of the present invention.

FIG. 5 shows a representation of an interface display for enabling a compliance packaging device's robotics to access appropriate batch files in some embodiments of the present invention.

FIG. 6 is a representation of an interface display for entering and modifying patient information in some embodiments of the present invention.

FIG. 7 is a representation of an interface display for allowing users to establish SIG codes in some embodiments of the present invention.

FIG. 8 is a representation of an interface display for pass times for establishing pass times for medications that are newly prescribed to patients in some embodiments of the present invention.

FIG. 9 is a representation of an interface display for performing various functions associated with batch files in some embodiments of the present invention.

FIG. 10 is a perspective view of a pre-packaged pill dispenser for use in some embodiments of the present invention.

FIG. 11 is a logical flow diagram of a method of providing medication compliance packaging according to some embodiments of the present invention.

### DESCRIPTION OF VARIOUS EMBODIMENTS

The following discussion is presented to enable a person skilled in the art to make and use embodiments of the invention. Various modifications to the illustrated embodiments will be readily apparent to those skilled in the art, and the generic principles herein may be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention. The following introductory material is intended to familiarize the reader with the general nature and some of the features of embodiments of the invention.

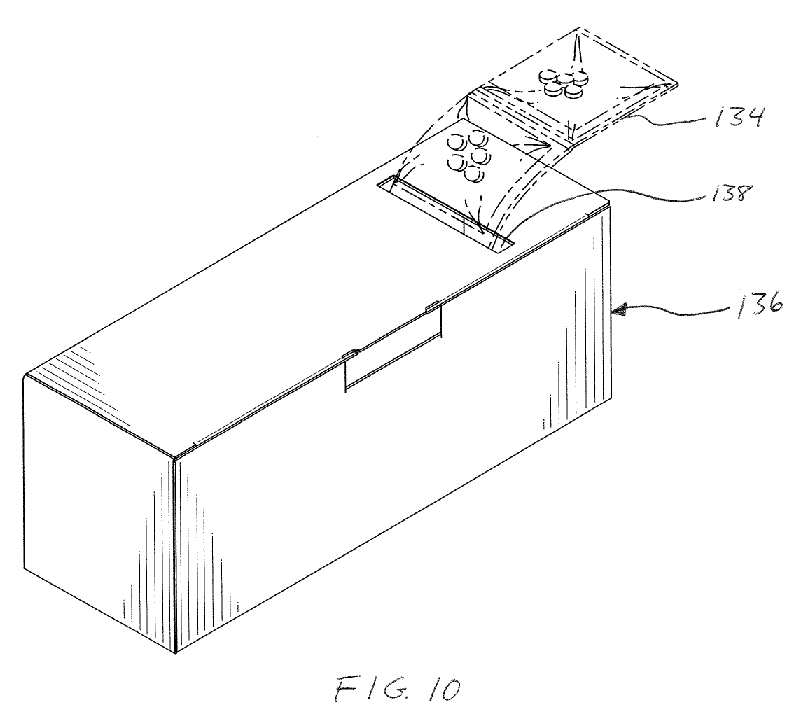

Some embodiments of the present invention provide for the creation of pouch tape rolls (134 of FIG. 10) for use by consumers in independent living situations. Such consumers, or their assistants, can administer medication from the pouch tape according to instructions on the pouch tape, thereby increasing the convenience and reducing administration errors. The pouches of the pouch tape are preferably easily separated and are marked with the patient's name, administration instructions and times, and a description of the medication or supplement meant to be sealed in the pouch. In this manner, a patient or caregiver may dispense pouches from the pouch tape serially in order to best ensure compliance with the prescribed treatment regimen. The pouch tape may also be filled or supplemented with non-prescription/over-the-counter medications and/or vitamins or capsulated nutritional supplements taken regularly by the subject patient.

In some embodiments, consumers consult with a retail pharmacist who can assess the consumer's various treatment regimens. This review, preferably in conjunction with computerized searching of drug interaction database information, will tend to reduce the risk that different doctors have prescribed, or the consumer is otherwise contemplating taking, incompatible medications or substances. The medications or substances are also preferably screened to determine whether they can be stored in the pouch tape and whether they can be combined for storage with other medications or should be stored individually.

In some embodiments of the present invention, a retail pharmacist can advantageously synchronize the consumer's various treatment regimens. In some embodiments, the synchronization can be a precursor to administering medication from a pouch tape. For example, as a consumer begins to administer a treatment regimen according to embodiments of the invention, each separate medication of the regimen can be assimilated into the pouch tape system as the consumer's traditional vial-dispensed supplies are exhausted. In some embodiments however, a retail pharmacist can synchronize some or all of a consumer's traditional vial-dispensed supplies so that each supply is exhausted at the same time. The consumer can then begin receiving all of his or her medications in a pouch tape, which allows the consumer to conveniently refill all the medications at once. For example, on the day a consumer visits a pharmacist, the consumer may have 10 days worth of a first medication remaining and 20 days worth of a second medication remaining. The pharmacist can synchronize the medications by providing the consumer with 10 days worth of the first medication in a traditional vial dispenser, and then start the consumer receiving both medications in a pouch tape at the end of 20 days when both medication supplies have been exhausted.

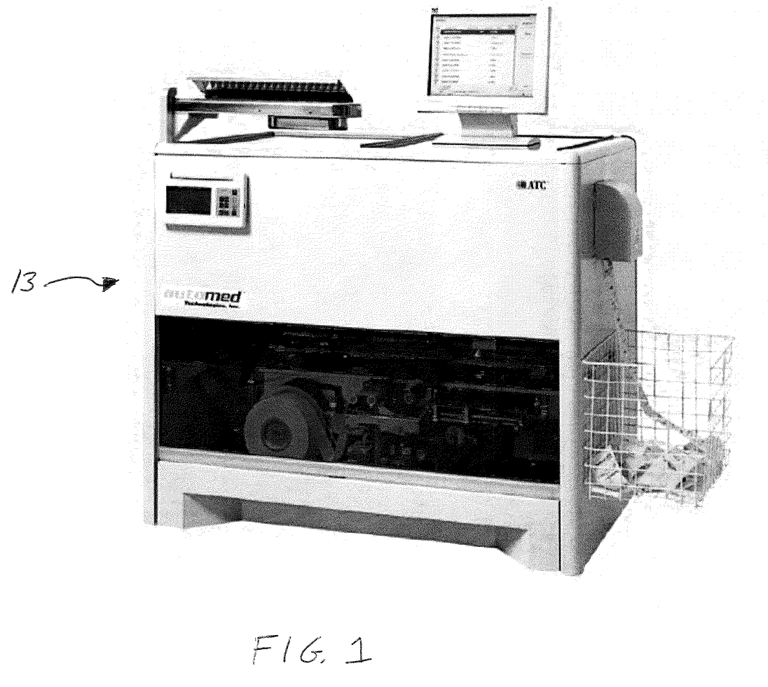

FIG. 1 shows an exemplary medication pouch tape creating device 13 that can be used in some embodiments of the present invention. Although embodiments of the present invention can make use of any suitable pouch tape creating device known in the art, in some embodiments, one suitable pouch tape creating device 13 is a FastPak™ 240 machine and accompanying software commercially available from AutoMed of Vernon Hills, Ill. According to an embodiment of the present invention, a computer interface is constructed between a retail or mail order pharmacy transaction system and software that operates the pouch tape creation device 13. The software interoperating with pouch tape creation device 13 may suitably be FastPak™ System Software available from AutoMed of Vernon Hills, Ill., which is described in the FastPak™ 220 System Software Manual Part # 2M9020 rev. 7/04, available from AutoMed and hereby incorporated by reference in its entirety. A suitable retail pharmacy transaction system in some embodiments is JASRx, published and distributed by Jascorp L.L.C. of Germantown, Wis.

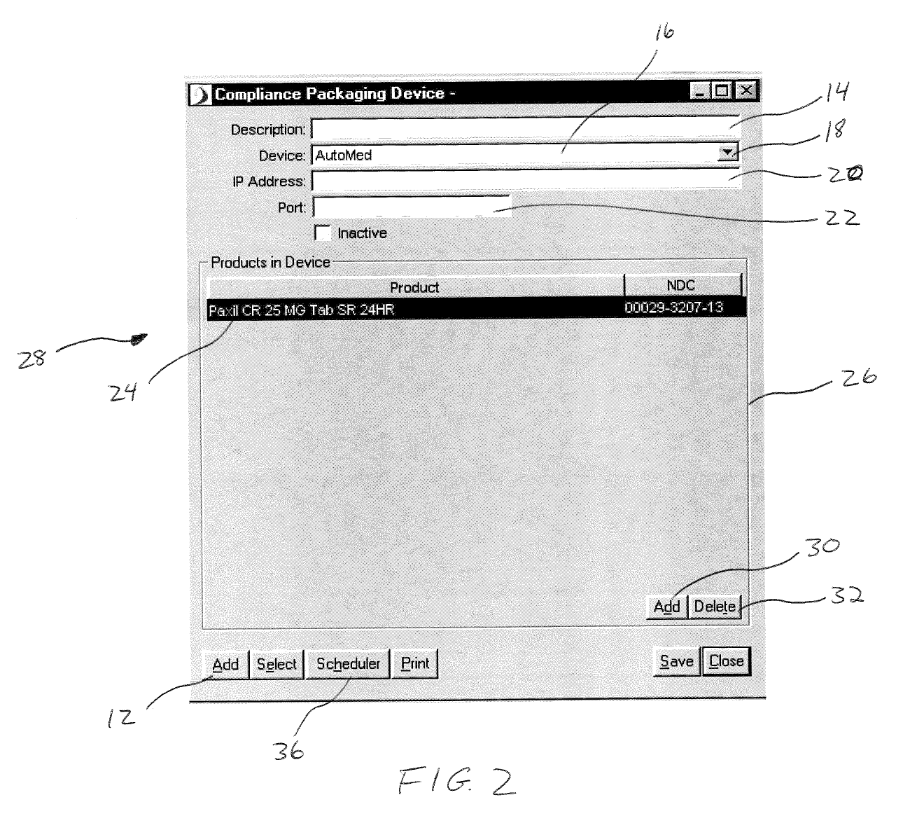

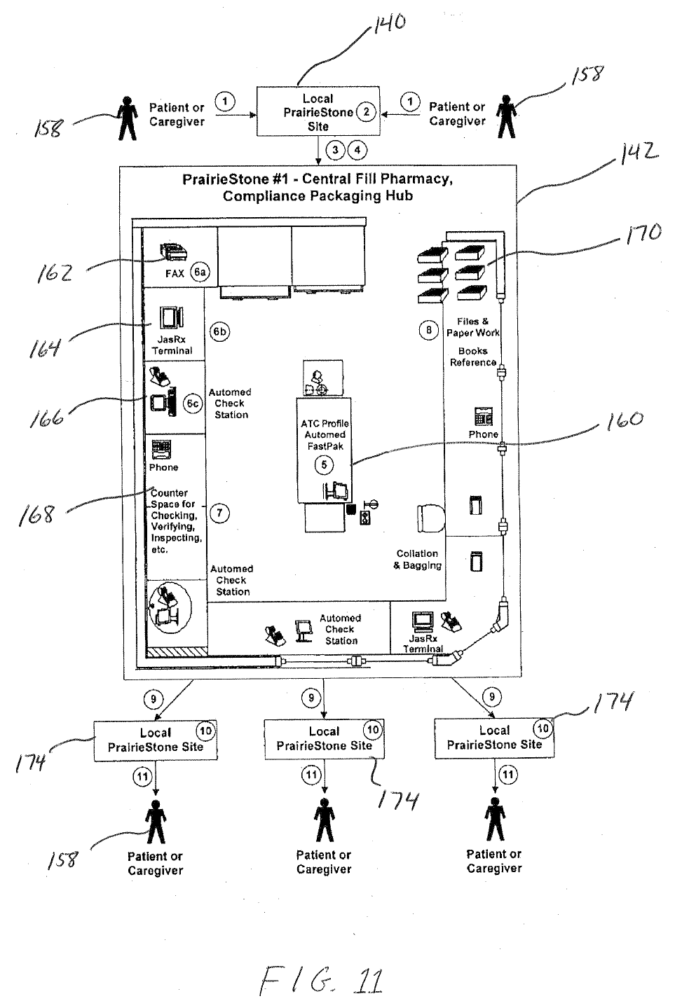

FIG. 2 shows an exemplary Packaging Device window 28 for initial setup of a compliance packaging device that can be used in some embodiments of the present invention. To construct a computer interface between a retail or mail-order pharmacy transaction system and a pouch tape creation device, the user can first set up the appropriate compliance packaging device. It is noted that this initial setup could be shared by all pharmacies in a multi-site configuration. To initiate the setup, the user can first open the utilities menu and select the Compliance Packaging option. Then, the user can select the Select Devices option to add a compliance packaging device. The user can enter a short name for the device being added in description field 14. A device type can then be selected in field 16 by using scroll button 18 to search for the desired device type. The device can then be selected by clicking on “Add” button 12. As can be seen AutoMed device has been chosen. Next the user can then enter the IP address assigned to the compliance packaging hub (142 of FIG. 11) in field 20 and the port in field 22.

In some embodiments, packaging Device window 28 allows users to modify which products are available to the compliance packaging devices they set up. Users can make additional products available to a compliance packaging device by first locating the device to which he or she desired to add products in field 16 with scroll button 18. Once the device is selected the user would click “Add” button 30 located at the bottom of “Products In Device” box 26. The user could then search for a product he or she would like to add to the selected device, select it, and click on “Add” button 30. The item would then be added to the list similar to item 24 shown in box 26. This process could then be repeated as many times as necessary to add all the products desired. Making an additional product available to a device enables a user to later fill prescriptions for that product using that device. In some embodiments, users can delete a product from being available to a device by highlighting a product on the list in box 26 and then clicking “Delete” button 32.

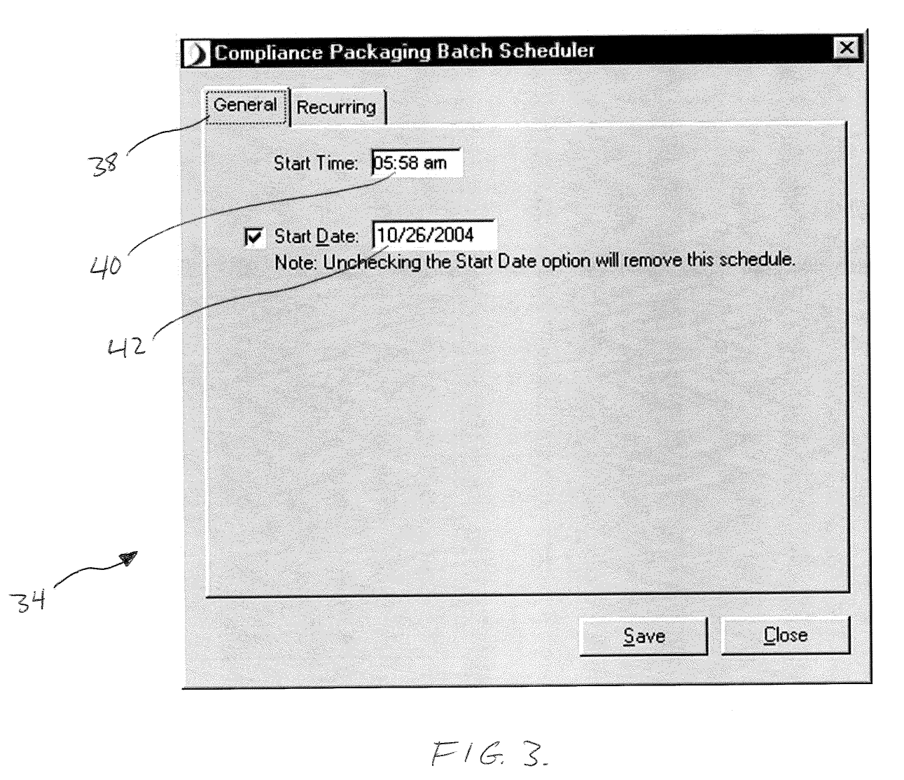

FIG. 3 shows an exemplary Scheduler window 34 that can be used to schedule when a pharmacy transaction system transfers pharmaceutical order information to a compliance packaging hub in some embodiments of the present invention. Pharmacy transaction systems, such as JASRx, can collect multiple prescription orders from consumers over the course of, e.g., a day. Rather than transferring each consumer's prescription order to the compliance packaging hub individually, pharmacy transaction systems typically transfer prescription order information to the compliance packaging hub only periodically, transferring all prescription orders collected since the last batch transfer. The user can reach scheduler window 34 by clicking on “Scheduler” box 36 of FIG. 2 located at Packaging Device window 28. Once the user has chosen a device for which he or she would like to schedule a batch transfer, the user would click on Scheduler button 36. In some embodiments, the scheduling option can be performed for each multi-site user. Referring again to FIG. 3, at General tab 38, the user can enter the time of day in start time box 40 when he or she would like the batch file transfers to begin. If transfer is to occur only once per day, this is when it will occur. At Start Date box 42, the user can enter the date when he or she would like the batch file transfers to begin. If the user wants the batch file transfers sent daily at the time indicated, then no further setup is necessary.

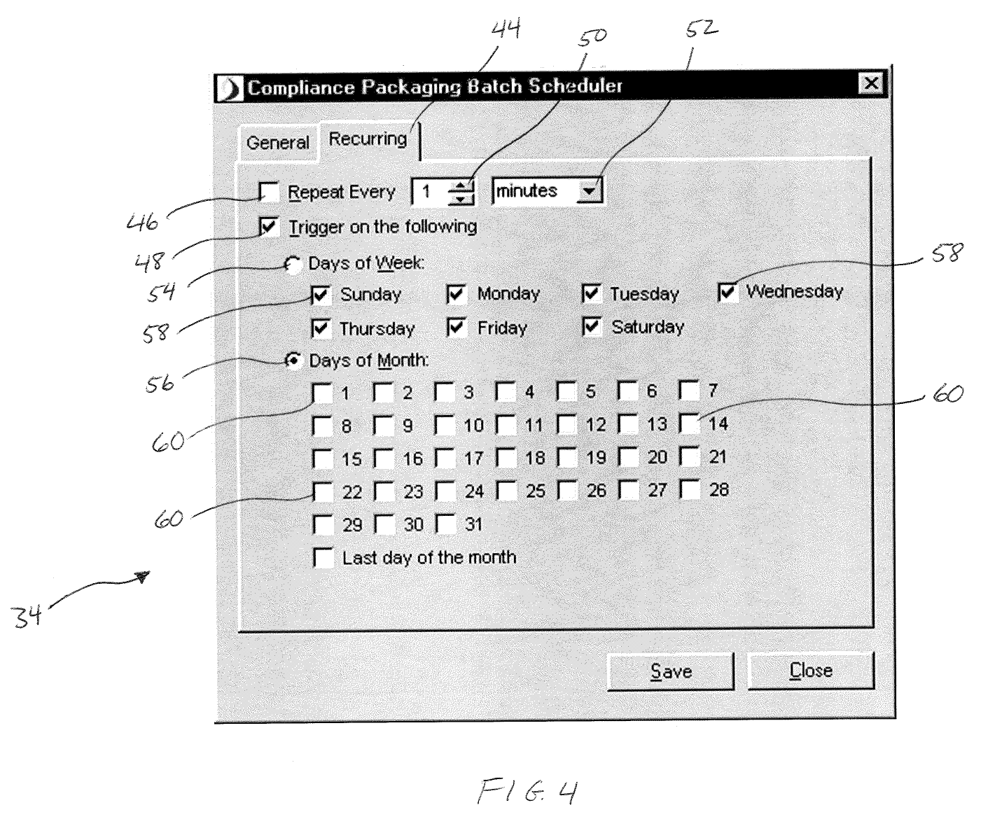

FIG. 4 shows the Scheduler window 34 of FIG. 3 with the “Recurring” tab 44 actuated rather than the “General” tab 38. By clicking on “Recurring” tab 44, the user can set the batch file transfers to be performed at intervals other than once per day (e.g., more frequently, only on certain days of the week or month, etc.). If the user desires for the file transfer to occur at a periodic pace, he or she can click on the “Repeat Every” box 46 to set the transfer at a periodic interval based in minutes, hours, days, weeks, months, or years based upon the date and time the user selected on General tab 38. Scroll bar 50 can be used to set the amount of the period, and scroll bar 52 can be used to set the time unit. If the user desires for the batch file transfers to occur at certain days of the week or month, they can click on the “Trigger” box 48 to select certain days of the week or certain days of the month. By clicking on circle 54 the user can select as many or as few days of the week (boxes 58) when they would like the file transfer to occur. By clicking on circle 56, the user can select as many or as few days of the week (boxes 60), including the last day of the month, for the file transfer to occur.

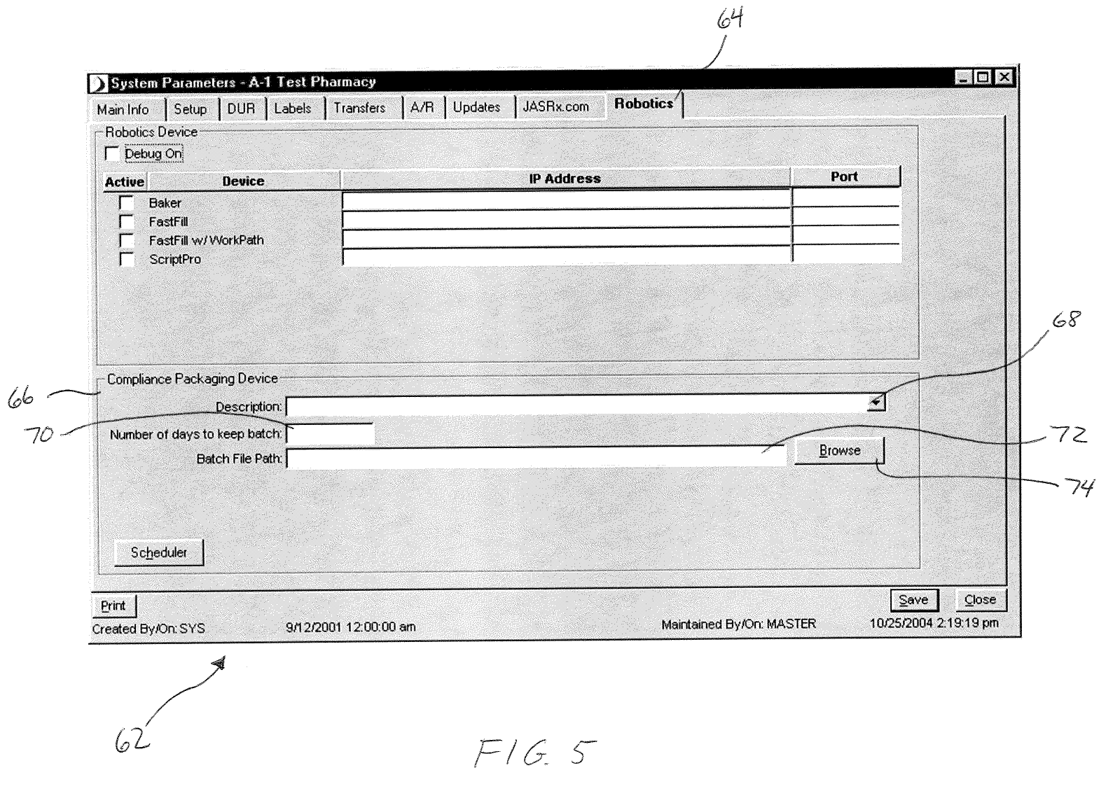

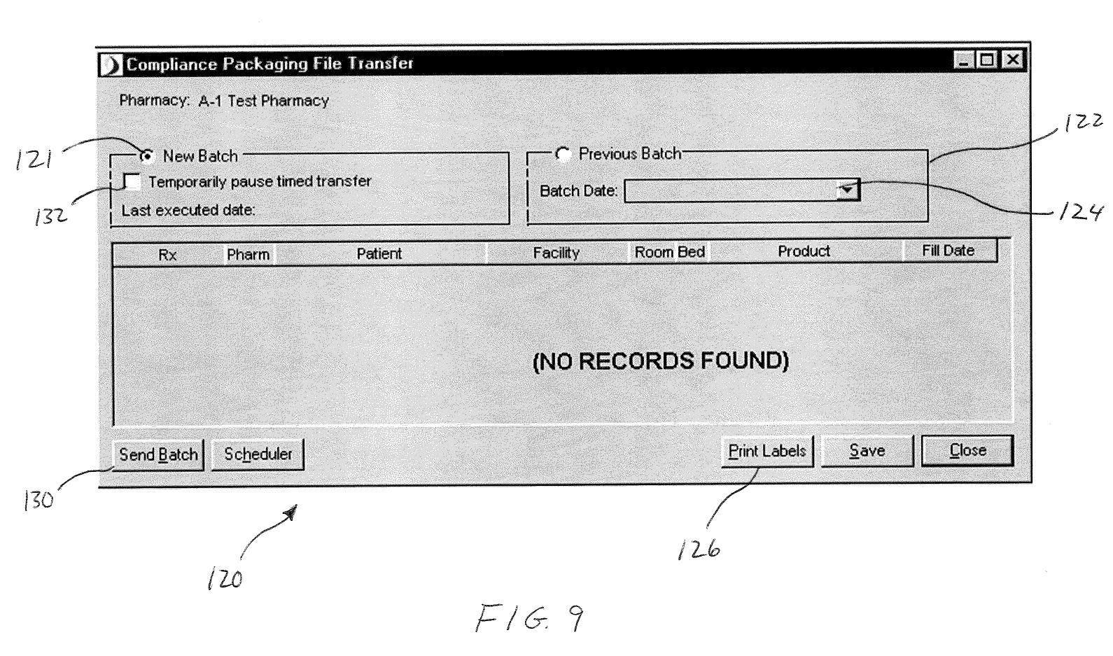

FIG. 5 shows an exemplary system parameters window 62 that can be used to enable a compliance packaging device's robotics to access the appropriate batch files in some embodiments of the present invention. A user can activate this screen by clicking on the “Robotics” tab 64 in the system parameters window 62. After the initial set up (or when necessary), the user can view all the devices he or she has loaded into the pharmacy transaction system at compliance packaging box 66 by clicking on “Description” drop-down box 68. The user can then select one of the loaded devices and then specify the location on the network where the batch files will be sent in box 72 so that the selected device can pick them up and process them. The user has the option of clicking on Browse button 74 to select from addresses that have already been entered. In some embodiments, the user can assign the length of time he or she wants to keep the batch files in the compliance packaging file transfer window (reference numeral 120 in FIG. 9) at box 70. This basically sets a time frame for the system to stop receiving batch files for the selected device in order to suitably accommodate workflow schedules.

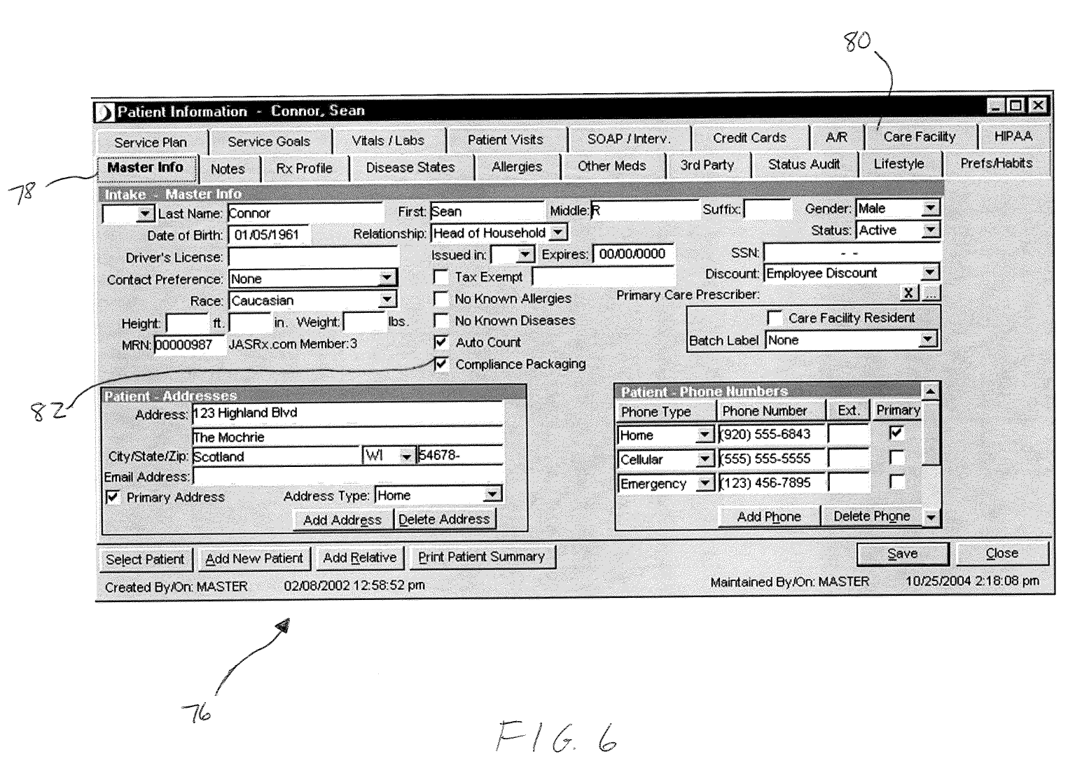

FIG. 6 shows an exemplary patient information window 76 for entering and modifying patient information that can be used in some embodiments of the present invention. At patient information window 76, the user can assign certain patients and/or care facilities to a pouch tape creation device. The user can click on Master Info tab 78 to begin the patient/care facility assigning process.

At patient information window 76, the user has a variety of options to choose from when setting up patients for compliance packaging. A first option allows users to assign all patients in a care facility, or in a given section/wing of a care facility, to a pouch creation device (e.g., by clicking on the Care Facility tab 80 and specifying accordingly). A second option, which is more germane to many embodiments of the present invention, allows users to mark individual patients for compliance packaging (box 82) on Master Info tab 78 of patient information window 76. In some embodiments, the user has other options as well. If the first option is utilized, the user may opt certain patients out of the compliance program from the care facility or section/wing simply by removing the mark from Compliance Packaging box 82 on Master Info tab 78 of patient information window 76. It is further contemplated that the patient and or facility could be set up to be cycle billed at tab 78 or tab 80 without departing from the spirit of the invention.

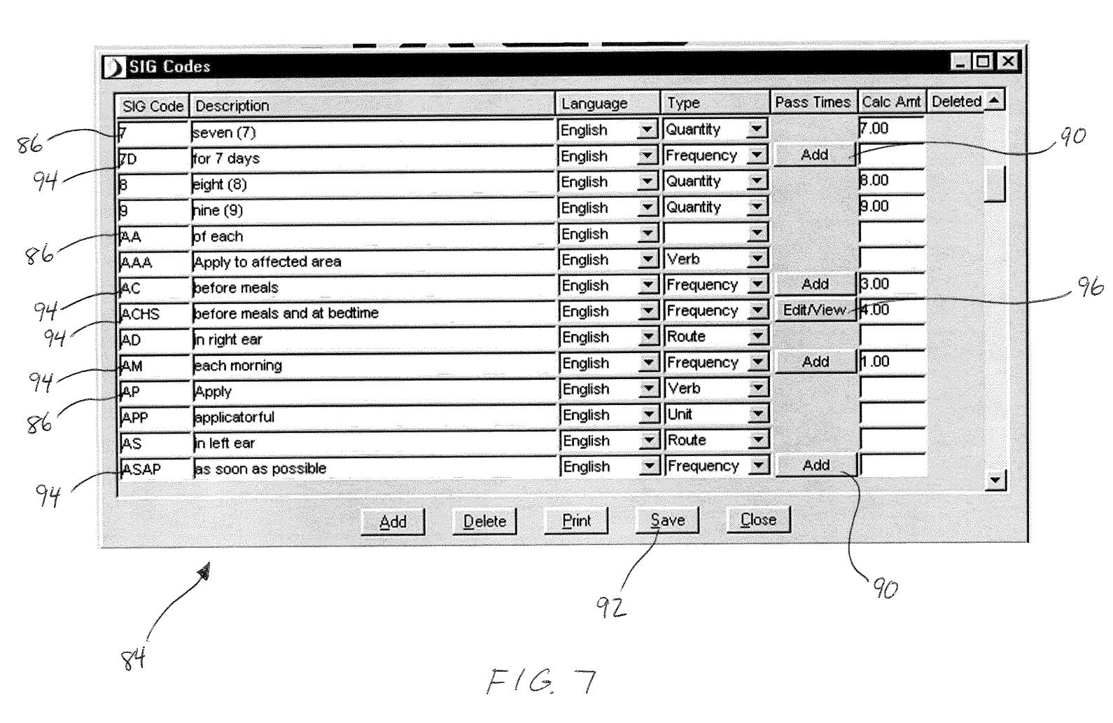

FIG. 7 shows an exemplary SIG code window 84 that can allow users to establish SIG codes for processing prescription orders in some embodiments of the present invention. A user can activate the SIG code window 84 from the Utilities menu. SIG code window 84 allows the user to establish default medication pass times for SIG codes 86 that refer to a frequency with which a medication is to be administered (hereinafter “Frequency codes” 94). An example of such a Frequency code 94 is “ACHS”—“before meals and at bedtime.” This Frequency code 94 refers to a frequency with which a medication is to be administered, but it does not specify pass times. In this example, the user can establish that the four default pass times for “ACHS” are, e.g., 8:00 am, 12:00 pm, 4:00 pm, and 8:00 pm.

The user can establish default medication pass times by clicking on the Add button 90 corresponding to a particular Frequency code 94. In response to the user clicking on the Add button 90, a window can appear having input fields for entering, e.g., eight pass times. For a Frequency code 94 like “7D”—“for 7 days”—the user can enter up to eight pass times for each day of the seven-day period. In some embodiments, this window can allow the user to establish a quantity of medication (e.g., number of doses) to be distributed at each pass time. When the user has established default information for the particular Frequency code 94, he or she can close the window and proceed establishing default information for other Frequency codes 94. In some embodiments, after default pass times have been established for a Frequency code 94, the Add button 90 automatically changes into an Edit/View button 96.

After the user established default medication pass times for each Frequency code 94, he or she can click on Save button 92 to save the default pass times. In some embodiments, if multiple sites (e.g., multiple patients or care facilities) are assigned to the same pouch creation device, these default pass times can apply to all sites.

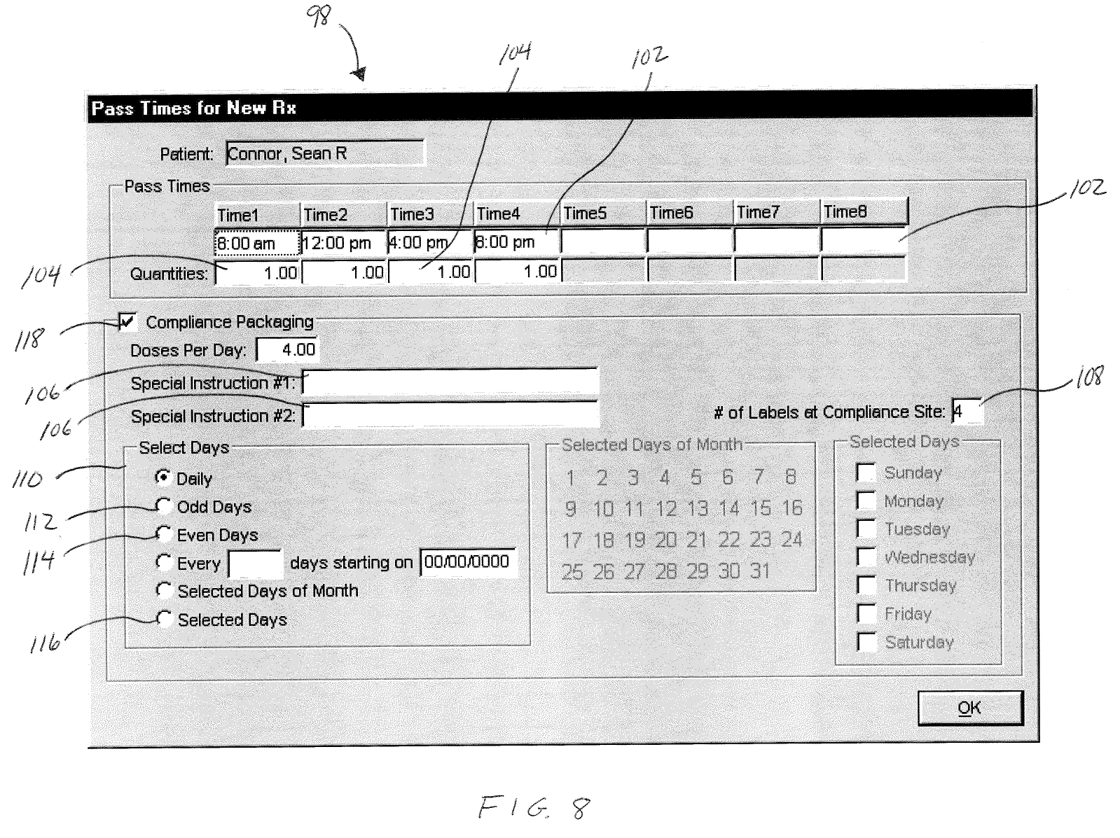

FIG. 8 shows an exemplary patient pass time window 98 that can be used in some embodiments of the present invention to establish pass times for a medication that is newly prescribed to a particular patient. Patient pass time window 98 allows the user to fill prescriptions using compliance packaging. In some embodiments, when the user enters a Frequency code, the patient pass time window 98 can be activated, provided that (a) the user is adding a new prescription for a patient marked as being a compliance packaging patient and (b) the medication has been assigned to a compliance device. Patient pass time window 98 can show the default information (e.g., pass times, quantity, etc.) entered by the user for the Frequency code (see FIG. 7 and corresponding discussion). The user can change the default information in the patient pass time window 98. For example, the user can change the pass times in boxes 102, the quantities in boxes 104, and so on.

The patient pass time window 98 allows the user to specify whether a particular prescription should go to the compliance packaging machine via box 118. If the user desires a prescription to go the compliance packaging machine, he or she can check box 118 and enter instructions in the Compliance Packaging window. The user has the option of choosing on what days the prescription is to be taken at select days box 110. If the medication is not taken daily, the user can select an option best suiting the schedule for the prescription (e.g., odd days circle 112, even days circle 114, or selected days 116). These instructions tell the compliance packaging machine how to fill the pouches so that pouches are provided that correspond only to the appropriate times. In some embodiments, the user is able to enter any special instructions he or she wants the compliance packaging device to print on the medication pouch in Special Instruction boxes 106. Because printing spaces are limited in many instances, it can be helpful if each box 106 is limited to 25 characters. Label box 108 displays the amount of retail labels that will print for this prescription when the labels are printed for the compliance packaging batch. In some embodiments, the user can revisit his or her decision to send the prescription to the compliance packaging machine each time the prescription is refilled.

FIG. 9 shows an exemplary file transfer window 120 that can be used for performing various functions associated with batch files in some embodiments of the present invention. As discussed above with reference to FIGS. 3-4 the user can schedule when batch files of compliance packaging prescription information are transferred to the compliance packaging hub. In some embodiments, when that time arrives, the batch file will transfer automatically. Once this batch file is transferred, it will then be shown as a previous batch file in previous batch box 122 in file transfer window 120. A user at the compliance packaging hub can print retail labels for the prescriptions by selecting the proper batch file from previous batch drop down list 124 and then click on print labels button 126. If individual prescriptions labels are printed at the site as well, the user would want to make sure there were no other prescriptions highlighted if they wanted the whole batch file printed at once. A user at a multi-site store or pharmacy who wants to view previous batch files can select the appropriate pharmacy from a drop down list of stores 128 (not shown). Users can gather and send batch files at times other than the scheduled transfer time by clicking in the New Batch circle 121 and then clicking on send batch button 130. If a batch file is being sent while the user has file transfer window 120 open, he or she may have to close the window and re-open it to view the batch file that was just sent. The user can prevent new batch files from being transferred (e.g., if there were something wrong with compliance machine) by marking the temporarily pause timed transfer box 132. This will prevent the scheduled file transfers until box 132 in un-checked.

FIG. 10 shows a perspective view of a pre-packaged pill dispenser that can be formed from a compliance packaging device in some embodiments of the present invention. Pouch tape 134 resulting from the above described process may be suitably dispensed to the consumer in a box 136 in which pouch tape 134 is rolled or fan-folded, with pouch tape 134 being accessible through an aperture 138 in the box's top surface. Box 136 in which pouch tape 134 is dispensed may be made of cardboard, or of a more durable material like wood, resin, or metal. Box 136 may be lockable or have a door or feed mechanism synchronized to a timer in order to aid in the administration of medication by the consumer and reduce opportunities for others, including children, to administer the drug improperly.

FIG. 11 shows a logical flow diagram of an exemplary method of providing medication compliance packaging according to some embodiments of the present invention. The first series of steps involve functions performed at a local pharmacy 140. A consumer (e.g., a patient or a caregiver) 158 can provide a prescription order to a local pharmacy 140 to be processed. The local pharmacy 140 can review and/or update the patient's profile, process the prescription, and adjudicate the claim. If the patient is a compliance packaging patient and the prescribed medication is accessible by a compliance packaging device, the prescription order can be entered. Once entered, the prescription order can be electronically queued and held as a batch file for the local pharmacy 140. In some embodiments, the local pharmacy 140 verifies the order by comparing it against the original hard copy prescription and performs validation steps to ensure that the proper prescription order is transferred. Often, the local pharmacy maintains the prescription number, along with the original prescription order (e.g., the hard copy written by a physician), on its local database even though the actual dispensing (multi-dose packaging) is performed at the compliance packaging hub 142. After verifying the prescription order, the local pharmacy 140 can transmit (e.g., fax, scan/e-mail, etc.) a copy of the original order to the compliance packaging hub 142. The compliance packaging hub 142 often retains the copy in its file so that it can conduct its “final check” of the prescription.

After the compliance packaging hub 142 is notified that local pharmacy 140 has a prescription order information batch file, the compliance packaging hub 142 can perform several functions in response. A pouch tape creation device 160 at the compliance packaging hub 142 can retrieve the batch file (as discussed above) corresponding to local pharmacy 140. In some embodiments, local pharmacy 140 can operate on a host-client based integrated operating system, thereby enabling all local pharmacy sites to access any patient within any of the databases. After retrieving the appropriate batch file, the pouch tape creation device 160 can dispense medication pursuant to the prescription in multi-dose packaging.

Stations 162, 164, 166 set forth a three-step validation process for each order. This process constitutes the “final check” and is typically performed by a pharmacist. First, the pharmacist can compare the order with the hard copy and validate it at the hard copy verification station 162. Then the pharmacist can review the order and the patient's profile/history at a pharmaceutical transaction station 164. Next, the pharmacist can visually inspect the order by comparing each individual multi-dose package against a virtual stock bottle—an image of the medication and its corresponding NDC (National Drug Code) number—at a virtual stock bottle station 166. In some embodiments, this three-step validation process can be performed out of consumers' view (e.g., on the back and side pharmacy counters) to prevent HIPAA (Health Insurance Portability and Accountability Act) complaints. Although this three-step validation process has been described in a particular order, many other orders are possible. For example, the pharmacist can use the virtual stock bottle station 166 before using the hard copy verification station. In some embodiments, a greater or lesser number of verification stations may be provided.

After the pharmacist validates and verifies the order, the order can be prepared to be sent to the proper local pharmacy 140. The order can be collated and placed in a labeled compliance packaging dispenser at an assembly station 168. Then, the order can be stored in a container (e.g., a sealed opaque delivery tote) that corresponds to the proper local pharmacy 140 until an appointed time (e.g., when all of the orders for a given day are completed). The containers can be stored at a storage station 170. At the appointed time, the containers can be made ready for shipping at a shipping station (not shown).

In some embodiments, when the compliance packaging hub 142 finishes its work, completed orders can be provided to the proper local pharmacies 140, 174. In such embodiments, the order corresponding to consumer 158 can be provided to local pharmacy 140. A pharmacist at local pharmacy 140 can perform an additional check and review the orders before presenting the prescription to the consumer 158. Finally, the pharmacist can present the order to the consumer 158 in a manner that conforms with applicable rules and regulations.

In some embodiments, when the compliance packaging hub 142 finishes its work, completed orders can be provided to a local pharmacy other than the local pharmacy from which the order came. For example, the compliance packaging hub 142 can provide the order corresponding to consumer 158 to local pharmacy 174, even though consumer 158 originally provided the order to local pharmacy 140. In such embodiments, the consumer 158 can arrange to retrieve the completed order from the different local pharmacy 174.

In some embodiments, when the compliance packaging hub 142 finishes its work, the compliance packaging hub 142 can send completed orders directly to consumers 158. In such embodiments, the compliance packaging hub 142 can send the pre-packaged pill dispensers via any suitable courier (e.g., U.S. mail, FedEx, UPS, etc.) 176 (not shown). Before doing so, a pharmacist at the compliance packaging hub 142 can perform additional verification steps that are designed to ensure that the medication remains safe and effective through the shipping process. For example, the pharmacist could make sure that the consumer would receive the pre-packaged pill dispenser before the enclosed medication expired or lost any of its effectiveness. In another example, the pharmacist can make sure that the pre-packaged pill dispenser will be shipped in an environment (e.g., temperature, humidity, etc.) that will not erode the medication's safety or effectiveness. Shipping pre-packaged pill dispensers directly to consumers can be advantageous in that it can save the time associated with the local pharmacy handling the pre-packaged pill dispensers.

Thus, embodiments of the SYSTEM AND METHOD OF PROVIDING MEDICATION COMPLIANCE PACKAGING are disclosed. One skilled in the art will appreciate that the present invention can be practiced with embodiments other than those disclosed. The disclosed embodiments are presented for purposes of illustration and not limitation, and the present invention is limited only by the claims that follow.

1. A computer-readable medium programmed with instructions for interfacing a compliance packaging device and a pharmacy transaction system, the medium comprising instructions for causing a programmable processor to:
accept a pharmaceutical order from a pharmacy transaction system user;
enter the pharmaceutical order into a database;
read the pharmaceutical order from the database; and
communicate the pharmaceutical order to the compliance packaging device.

2. The medium of claim 1, further comprising instructions for causing a programmable processor to display a patient's pharmacological profile.

3. The medium of claim 2, further comprising instructions for causing a programmable processor to update the patient's pharmacological profile.

4. The medium of claim 3, wherein the pharmaceutical order is stored in the database as a batch file for a specific pharmacy site.

5. The medium of claim 4, wherein the pharmacy site comprises a retail pharmacy or a mail order pharmacy.

6. The medium of claim 1, wherein the pharmaceutical order is entered at a pharmacy site remote from a site housing the compliance packaging device.

7. The medium of claim 6, further comprising instructions for causing a programmable processor to allow the user to select the compliance packaging device.

8. A computer-readable medium programmed with instructions for interfacing a compliance packaging device and a pharmacy transaction system, the medium comprising instructions for causing a programmable processor to: accept a pharmaceutical order entered by a pharmacy transaction system user at a first site;
enter the pharmaceutical order into a database at the first site;
read the pharmaceutical order from the database at the first site from a second site; and
communicate the pharmaceutical order to the compliance packaging device at the second site.

9. The medium of claim 8, wherein the transaction system user can set scheduled times to transfer pharmaceutical orders to the second site.

10. The medium of claim 8, wherein the transaction system user can select the compliance packing device.

11. The medium of claim 8, wherein the compliance packaging device produces a medication pouch tape.

12. The medium of claim 8, further comprising instructions for causing a programmable processor to review and update a patient's pharmacological profile.

13. A method for providing medication compliance packaging comprising the following steps:
entering a pharmaceutical order into a database at a local pharmacy;
reading the pharmaceutical order from the database; and
communicating the pharmaceutical order to a compliance packaging device at a compliance packaging hub.

14. The method of claim 13, further comprising the step of receiving the pharmaceutical order from a patient at a first site.

15. The method of claim 14, further comprising the step of reviewing a pharmacological profile of the patient stored on the database.

16. The method of claim 15, further comprising the step of verifying the pharmaceutical order on the database against a hard copy of the pharmaceutical order.

17. The method of claim 16, further comprising the step of pulling the pharmaceutical order from the local pharmacy to the compliance packaging hub.

18. The method of claim 17, further comprising the step of scheduling times for the pharmaceutical order to be pulled from the local pharmacy.

19. The method of claim 18, further comprising the step of selecting a compliance packaging device.

20. The method of claim 19, further comprising the step of storing a medication pouch tape created by the compliance packaging device in a pill dispenser box.

21. The method of claim 13, further comprising the step of verifying at the compliance packaging hub the pharmaceutical order communicated to the compliance packaging device against a hard copy of the pharmaceutical order.

22. The method of claim 13, wherein the pharmaceutical order corresponds to a patient, and further comprising the step of comparing at the compliance packaging hub the pharmaceutical order communicated to the compliance packaging device with a pharmacological profile of the patient.

23. The method of claim 13, further comprising the step of comparing at the compliance packaging hub a packaged medication with an image of an ordered medication corresponding to the pharmaceutical order communicated to the compliance packaging device.

24. The method of claim 23, further comprising the step of comparing the packaged medication with a National Drug Code of the ordered medication.

25. A method for providing medication compliance packaging, comprising:
receiving a first pharmaceutical order from a first pharmacy transaction system, the first pharmaceutical order corresponding to a prescription of a first consumer;
generating a first medication pouch tape with a compliance packaging device in response to the first pharmaceutical order; and
providing the first medication pouch tape to the first consumer.

26. The method of claim 25, wherein the first pharmacy transaction system is located at a first remote location.

27. The method of claim 26, further comprising:
receiving a second pharmaceutical order from a second pharmacy transaction system located at a second remote location, the second pharmaceutical order corresponding to a prescription of a second consumer;
generating a second medication pouch tape with the compliance packaging device in response to the second pharmaceutical order; and
providing the second medication pouch tape to the second consumer.

28. The method of claim 25, further comprising packaging the first medication pouch tape in a box, wherein providing the first medication pouch tape to the first consumer comprises providing the box to the first consumer.

29. The method of claim 28, wherein the box is synchronized to a timer.

30. The method of claim 25, wherein providing the first medication pouch tape to the first consumer comprises sending the first medication pouch tape directly to the first consumer.

31. The method of claim 25, wherein providing the medication pouch tape to the first consumer comprises providing the medication pouch tape to a third pharmacy located at a third remote location.

32. The method of claim 25, further comprising receiving instructions for assigning a medication product to the compliance packaging device.

33. The method of claim 25, further comprising a plurality of pharmaceutical orders in a batch file, the plurality of pharmaceutical orders including the first pharmaceutical order.

34. The method of claim 25, further comprising receiving instructions for informing the compliance packaging device how to retrieve the first pharmaceutical order.

35. The method of claim 25, further comprising receiving instructions for printing a label to be affixed to the first medication pouch tape.

36. A method for providing medication compliance packaging, comprising:
generating a first pharmaceutical order that corresponds to a prescription of a consumer;
providing the first pharmaceutical order to a compliance packaging hub that is configured to generate a medication pouch tape with a first compliance packaging device in response to the first pharmaceutical order; and
receiving the medication pouch tape from the compliance packaging hub.

37. The method of claim 36, wherein the compliance packaging hub is located at a remote location.

38. The method of claim 36, further comprising selecting the first compliance packaging device from a plurality of compliance packaging devices accessible to the compliance packaging hub.

39. The method of claim 36, further comprising collecting a plurality of pharmaceutical orders in a first batch file, the first batch file including the first pharmaceutical order wherein providing the first pharmaceutical order to the compliance packaging hub comprises providing the first batch file to the compliance packaging hub.

40. The method of claim 39, further comprising scheduling a series of times for providing batch files to the compliance packaging hub, wherein providing the first batch file to the compliance packaging hub comprises providing the first batch file at one of the scheduled times.

41. The method of claim 36, further comprising:
generating a second pharmaceutical order that corresponds to the prescription of the consumer; and
dispensing medication in response to the second pharmaceutical order via a vial-dispensed system.

42. The method of claim 36, wherein generating the first pharmaceutical order comprises using a SIG code that refers to a frequency with which a medication is to be administered but does not specify a pass time.

43. The method of claim 42, further comprising establishing a default pass time for the SIG code.

44. The method of claim 43, further comprising modifying the default pass time for the consumer.

45. The method of claim 36, further comprising:
generating instructions concerning printing a label to be affixed to the medication pouch tape; and
providing the instructions to the compliance packaging hub.

46. The method of claim 36, further comprising providing a hard copy of the prescription to the compliance packaging hub.
